(19) United States
(12) Patent Application Publication
(10) Pub. No.: US 2011/0087389 A1
(43) Pub. Date: Apr. 14, 2011

(54) STANDBY MODE FOR OPTIMIZATION OF EFFICIENCY AND DURABILITY OF A FUEL CELL VEHICLE APPLICATION

(75) Inventors: Darrell W. Burleigh, Honeoye Falls, NY (US); David A. Arthur, Honeoye Falls, NY (US); Abdullah B. Alp, West Henrietta, NY (US); Seth E. Lerner, Honeoye Falls, NY (US); Akbar Chowdhury, Pittsford, NY (US); David R. Savage, Webster, NY (US)

(73) Assignee: GM GLOBAL TECHNOLOGY OPERATIONS, INC., DETROIT, MI (US)

(21) Appl. No.: 12/723,261

(22) Filed: Mar. 12, 2010

Related U.S. Application Data
(60) Provisional application No. 61/250,447, filed on Oct. 9, 2009.

(51) Int. Cl. G06F 19/00

(52) U.S. Cl. 701/22

(57) ABSTRACT

A system and method for putting a fuel cell vehicle system into a stand-by mode where there is little or no power being consumed, the quantity of fuel being used is minimal and the fuel cell system is able to quickly recover from the mode. The method includes determining whether predetermined stand-by mode vehicle level entrance criteria have been satisfied at a vehicle control level and predetermined stand-by mode fuel cell level entrance criteria have been satisfied for a fuel cell system control level, and putting the vehicle in the stand-by mode if both the vehicle level entrance criteria and the fuel cell level entrance criteria have been satisfied. The method exits the stand-by mode if predetermined vehicle level exit criteria have been satisfied or predetermined fuel cell level exit criteria have been satisfied.

### CROSS-REFERENCE TO RELATED APPLICATIONS

This application claims the benefit of the priority date of U.S. Provisional Patent Application Ser. No. 61/250,447, titled Standby Mode for Optimization of Efficiency and Durability of a Fuel Cell Vehicle Application, filed Oct. 9, 2009.

### BACKGROUND OF THE INVENTION

1. Field of the Invention

This invention relates generally to a system and method for putting a fuel cell system into a stand-by mode and, more particularly, to a system and method for putting a fuel cell system into a stand-by mode where there is little or no power being consumed, the amount of fuel being used is minimal and the fuel cell system can recover quickly from the stand-by mode.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between the two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

Under certain fuel cell system operating conditions, it may be desirable to put the system in a stand-by mode where the system is consuming little or no power, the quantity of fuel being used is minimal and the system can quickly recover from the stand-by mode so as to increase system efficiency and reduce system degradation. In one example, when the fuel cell system is in an idle mode, such as a fuel cell vehicle being stopped at a stop light, where the fuel cell stack is not generating power to operate system devices, cathode air and hydrogen gas are still being provided to the fuel cell stack, and the stack is generating output power. Providing hydrogen gas to the fuel cell stack when it is in the idle mode is generally wasteful because operating the stack under this condition is not producing very much useful work. Thus, it is generally desirable to reduce stack output power and current draw during these idle conditions to improve system fuel efficiency.

### SUMMARY OF THE INVENTION

In accordance with the teachings of the present invention, a system and method are disclosed for putting a fuel cell vehicle system into a stand-by mode where there is little or no power being consumed, the quantity of fuel being used is minimal and the fuel cell system is able to quickly recover from the mode. The method includes determining whether predetermined stand-by mode vehicle level entrance criteria have been satisfied at a vehicle control level and predetermined stand-by mode fuel cell level entrance criteria have been satisfied for a fuel cell system control level, and putting the vehicle in the stand-by mode if both the vehicle level entrance criteria and the fuel cell level entrance criteria have been satisfied. The method exits the stand-by mode if predetermined vehicle level exit criteria have been satisfied or predetermined fuel cell level exit criteria have been satisfied.

Additional features of the present invention will become apparent from the following description and appended claims, taken in conjunction with the accompanying drawings.

### BRIEF DESCRIPTION OF THE DRAWINGS

FIG. 1 is a schematic block diagram of a fuel cell system; and

FIGS. 2(a)-2(c) are a flow chart diagram showing a process for entering and exiting a stand-by mode in the fuel cell system.

### DETAILED DESCRIPTION OF THE EMBODIMENTS

The following discussion of the embodiments of the invention directed to a system and method for putting a fuel cell system in a stand-by mode is merely exemplary in nature, and is in no way intended to limit the invention or its applications or uses. For example, the present invention has particular application for putting a fuel cell system associated with a hybrid fuel cell vehicle in a stand-by mode. However, as will be appreciated by those skilled in the art, the system and method of the invention will have application for other fuel cell systems.

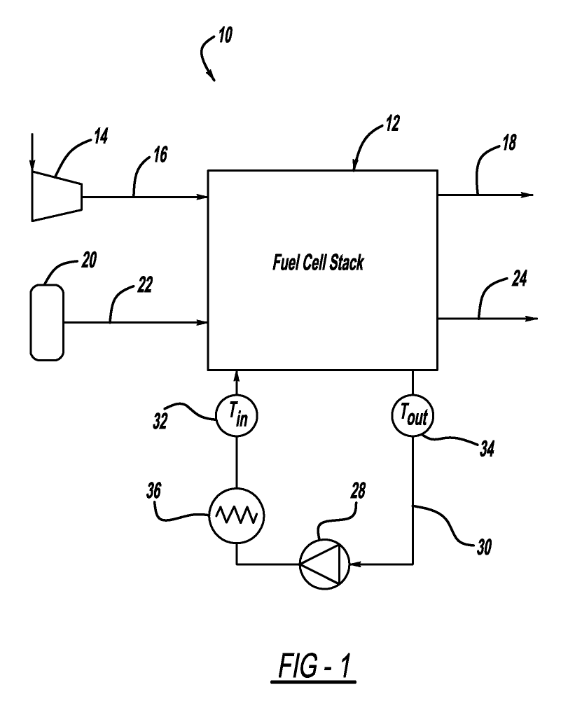

FIG. 1 is a simplified schematic plan view of a fuel cell system 10 including a fuel cell stack 12. The fuel cell stack 12 includes a cathode side that receives air from a compressor 14 on a cathode input line 16 and provides a cathode exhaust gas on a cathode exhaust gas line 18. The fuel cell stack 12 also includes an anode side that receives a hydrogen gas from a hydrogen source 20, such as a high pressure tank, on an anode input line 22 and provides an anode exhaust gas on an anode exhaust gas line 24. The system 10 further includes a thermal sub-system that provides a cooling fluid flow to the fuel cell stack 12. The thermal sub-system includes a high temperature pump 28 that pumps the cooling fluid through a coolant loop 30 external to the fuel cell stack 12 and through the cooling fluid flow channels in the bipolar plates in the fuel cell stack 12. A temperature sensor 32 measures the temperature of the cooling fluid in the coolant loop 26 as it enters the fuel cell stack 12 and a temperature sensor 34 measures the temperature of the cooling fluid in the coolant loop 26 as it exits the fuel cell stack 12. A cooling fluid heater 36 is provided in the coolant loop 30 and can be used to increase the temperature of the cooling fluid flowing through the coolant loop 30. The heater 36 can be any heater suitable for the purposes described herein, such as a resistive heater.

The present invention proposes a system and method for putting the fuel cell system 10 into a stand-by mode where there is little or no power being consumed, the quantity of fuel being used is minimal and the system is able to recover quickly from the stand-by mode. The definition of little or no power consumed is to shut down or set the system to a low power setting for as many parasitic loads as practical, such as the compressor 14, the cooling fluid heater 36 and any other non-critical parasitic loads. The definition of minimal quantity of fuel is that the quantity of hydrogen flowing into the stack 12 is reduced to a level to maintain a pressure set-point that could be a vacuum, but should not be allowed to draw a vacuum that could cause potential damage to the stack 12. The purpose of the stand-by mode is to improve the efficiency of the fuel cell system 10 by reducing the energy and fuel being consumed that would otherwise normally be consumed if no change was made. The stand-by mode may be entered during any suitable system operating conditions, such as when the vehicle is idling, is stopped, is traveling at a steady-state low speed, etc. If the system 10 is operating at low power and inefficiently, it may be desirable to use battery power to operate the system assuming that the battery state of charge is high enough.

The present invention requires certain entrance criteria to be satisfied to put the system 10 into the stand-by mode. The entrance criteria can be sub-divided into two major classifications, namely, vehicle level entrance criteria and fuel cell module level criteria. The basic vehicle level criteria include, but are not limited to, the key state is crank-to-run or run position, the PRNDL position allows stand-by, the brake switch state allows stand-by, a hybrid vehicle battery state-of-charge (SOC) is greater than a predetermined upper threshold, a vehicle heating, ventilation and air condition (HVAC) system state allows the stand-by mode where no cabin heating or air conditioning is being requested, a vehicle level fault status allows stand-by where no service indicator lamp has been illuminated, the vehicle speed is below a maximum threshold speed, low fuel cell power is required, an economy mode selector switch state is in the economy position, and the distance from home, work or other locations in the navigation system is greater than a threshold.

These criteria are used to determine if entering the stand-by mode will optimize the overall hybrid system efficiency within the bounds of maintaining passenger comfort. If so, the stand-by mode will be requested at the vehicle level.

The fuel cell module level entrance criteria include the fuel cell operating temperature is above a predetermined threshold temperature, a fuel cell fault status is proper, the fuel cell run time is greater than a predetermined threshold, and whether there was a previous ineffective stand-by mode to run state transition. The fuel cell level entrance criteria are used to determine the capability of the fuel cell to enter the stand-by mode in a robust fashion while minimizing operator disturbance at transition and durability impacts.

The process also proposes a number of exit criteria for exiting the stand-by mode, which also can be divided into vehicle level and fuel cell module level criteria. The vehicle level exit criteria are analogous to those for the stand-by entrance criteria and include the key is not in crank-to-run or run position, there is a PRNDL position transition to a stand-by inhibit state provided, there is a brake switch state transition to a stand-by inhibit state provided, the hybrid battery state-of-charge is less than a minimum SOC threshold, there is a HVAC system state transition to a stand-by inhibit state being provided, there is a vehicle level fault status change to stand-by inhibit state being provided, the vehicle speed is greater than a maximum threshold speed, there is a high fuel cell required power, the economy mode selector switch state is not in the economy mode, and the distance from home, work or other location in the navigation system is less than a predetermined threshold.

The fuel cell level exit criteria for exiting the stand-by mode are analogous to those in the stand-by entrance criteria for the fuel cell level and include the fuel cell operating temperature is below a predetermined threshold temperature, there is a fuel cell fault status transition to a stand-by inhibit state being provided, a fuel cell time in the stand-by is greater than a predetermined threshold, and the anode hydrogen concentration is less than a predetermined threshold.

Based on the above entrance and exit criteria, several factors are managed by the vehicle fuel cell power module (FCPM) and the fuel cell system (FCS) controller including key position; fuel cell required power; PRNDL position; HVAC system state; brake switch state; vehicle location; vehicle speed, where the operator uses fuel cell system mode indicators for passenger comfort and expected fuel cell power requirements are provided; a hybrid battery SOC, where the battery must provide power to maintain the vehicle systems during the stand-by mode and minimally retain enough energy to restart the fuel cell system upon exit of the stand-by mode; a vehicle/fuel cell level fault status, where verification is required of actuators and sensor availability; an economy mode selector switch that allows an operator to choose system operation optimization for fuel economy rather than performance criteria; a fuel cell operating temperature having stand-by mode exit restart robustness; a fuel cell minimum run time that includes post start stabilization and operator entrance/exit frequency disturbance; a fuel cell maximum time in the stand-by mode, where the stand-by mode exit restart robustness impact of components; temperature/freeze potential; an anode hydrogen concentration, where a stand-by exit restart robustness due to impact on emissions and the trade-off of restart time minimization versus stability is provided; and a previous ineffective stand-by mode exit transition that maintains fuel cell operation robustness.

The FCS controller maintains control of the anode pressure to a define a set-point while in the stand-by mode. This allows control optimization for minimizing restart time upon exiting the stand-by mode and restart robustness based on cell reliability. Vehicle hydrogen sensor levels may be monitored as required. The air flow to the cathode may be controlled for controlled hydrogen concentration in the plumbing and restart robustness as required.

The stand-by mode protocol has three exit criteria paths that include exit due to other than operator key-down, exit due to operator key-down with low freeze potential predicted, and exit due to operator key-down with high freeze potential predicted. Under the first path, the fuel cell control executes the operations required to restart the fuel cell and return to normal power operation. Under the second and third paths, the input with regards to a freeze potential is obtained as an algorithm input. Factors that could be used in this prediction include, but are not limited to, environmental condition sensor inputs, such as ambient temperature, barometric pressure, etc., statistical weather data for the vehicle deployment region, predicted weather condition for the current location based on the navigation system input and customer usage profile. If the predicted freeze potential is low, the system is allowed to transition to the off state. However, if the predicted freeze potential is high, the restart and purge cycle to dry out the stack membranes is required to increase the robustness of the subsequent start.

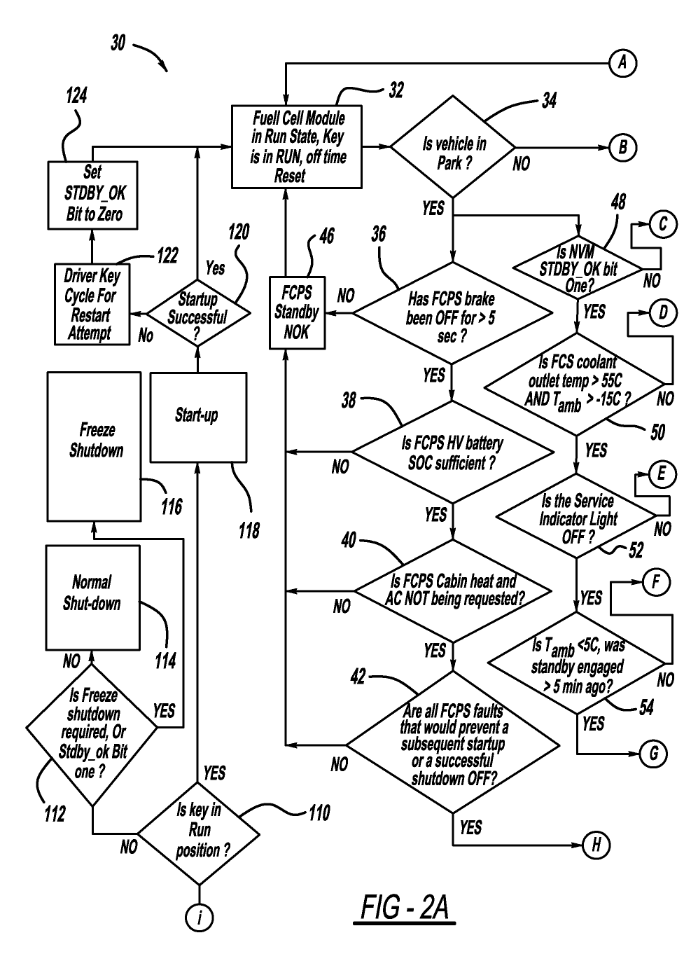

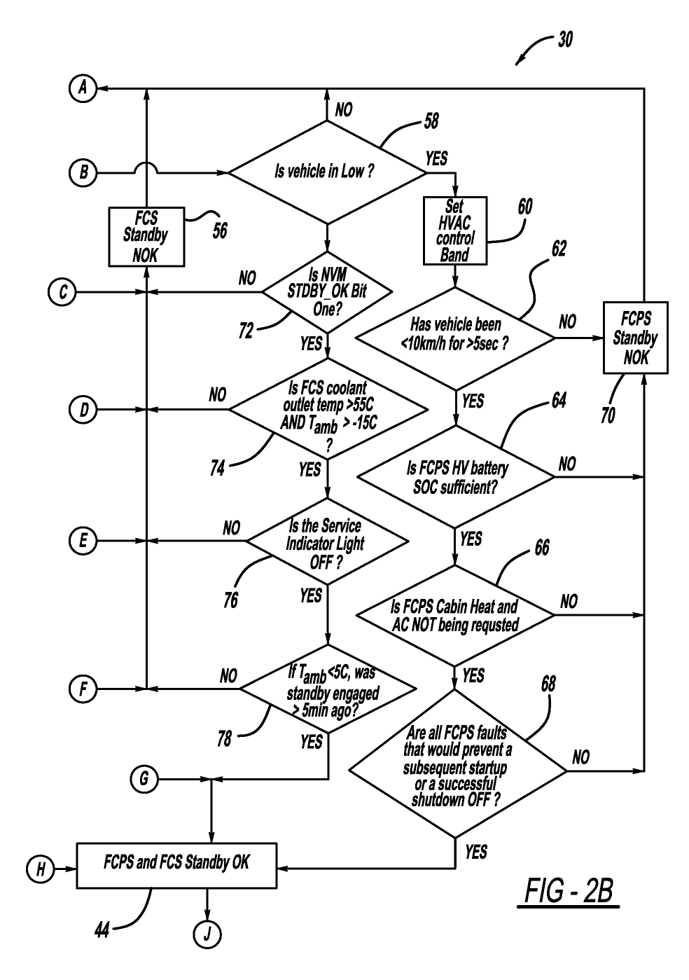

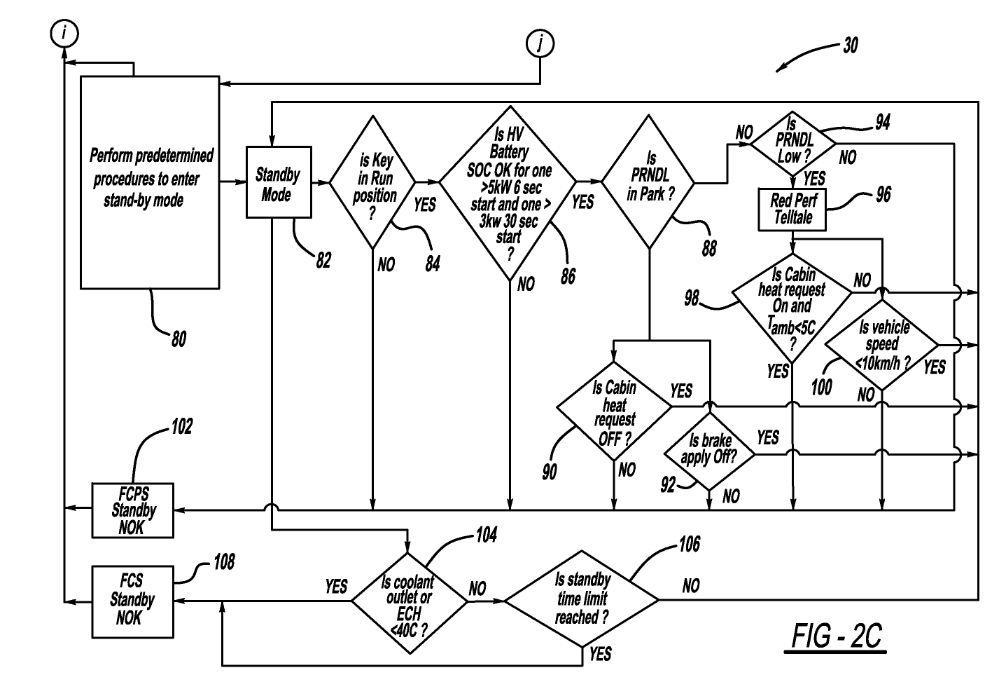

FIGS. 2(a)-2(c) are a flow chart diagram 30 showing an operation of entering and exiting the stand-by mode based on the entrance and exit criteria discussed above and the various parameters that the fuel cell system monitors. As discussed above, there are entrance and exit criteria for the vehicle level and there are entrance and exit criteria for the fuel cell module level. Those criteria are separately identified in the flow chart diagram 30 as being a FOPS controller for the vehicle level control and a FCS controller for the fuel cell level control. In this regard, if all the entrance or exit criteria are met at the FOPS controller, then the FOPS controller will send a request for entering or exiting the stand-by mode and the FCS controller will determine if the stand-by mode is actually entered or exited based on its criteria.

To enter the stand-by mode, the algorithm first determines whether the fuel cell module is in the run state, the ignition key is in the run position and the vehicle off-time has been reset at box 32. If these entrance criteria have been met, then the algorithm determines at the vehicle level whether the PRNDL position is park at decision diamond 34. If the vehicle is in park at the decision diamond 34, then the algorithm determines entrance criteria for both the vehicle level and the fuel cell level. For the vehicle level, the algorithm determines if the FOPS brake has been off for more than a predetermined period of time, such as five seconds, at decision diamond 36, and if so, determines if the FOPS high voltage battery state-of-charge is sufficiently high at decision diamond 38, and if so, determines whether the FOPS cabin heating or air conditioning are not being requested at decision diamond 40, and if so, determines if all of the FOPS faults that would prevent a subsequent start-up or a successful shut-down are in the off state at decision diamond 42. If all of the entrance criteria have been met, then the FOPS controller indicates that it is OK to enter the stand-by mode at box 44. If any of the entrance criteria at the diamonds 36, 38, 40 and 42 is not satisfied, then the algorithm determines that the vehicle cannot be put in the stand-by mode at box 46, and returns to determining whether the fuel cell module is in the run position, the key is in the run position, and the off-time is reset at the box 32.

If the PRNDL position is in park at the decision diamond 34, then the FCS controller determines whether a stand-by bit has been set in a non-volatile memory (NVM) at decision diamond 48 that indicates whether the system has exited a previous stand-by mode properly, where if the bit is not set, the system requires technical servicing to determine whether a problem exists. If the stand-by bit is one at the decision diamond 48, then the algorithm determines whether the fuel cell stack coolant outlet temperature is greater than a predetermined temperature, such as 55° C., and the ambient temperature T_{amb} is greater than a predetermined temperature value, such as −15° C., at decision diamond 50, and if so, the algorithm determines if a service indicator light is off at decision diamond 52, and if so, the algorithm determines whether the ambient temperature T_{amb} is less than a predetermined temperature value, such as 5° C., and was the stand-by mode engaged more than a previous predetermined time period, such as 5 minutes, at decision diamond 54. If all of these entrance criteria have been met, the FCS controller activates the stand-by mode at the box 44. However, if any of the entrance criteria at the diamonds 48, 50, 52 and 54 has not been satisfied, then the FCS controller determines that the stand-by mode is not OK at box 54 and the algorithm returns to the box 32 to determine whether the key is in the run position, the fuel cell module is in the run state and the off-time is reset.

If the PRNDL position is not park at the decision diamond 34, then the algorithm determines whether the vehicle is in a low power condition, such as an economy mode, at decision diamond 58, and if not, the algorithm returns to the box 32 to determine if the key is in the run position, the fuel cell module is in the run state and the off-time is reset. In one embodiment, the PRNDL is used as an economy mode switch where if the PRNDL is in low then the economy mode has been activated. If the vehicle is in the low power condition at the decision diamond 58, then, at the vehicle FOPS controller level, the algorithm puts the HVAC control in a set-up band at box 60. The algorithm then determines if the vehicle has been traveling less than a predetermined speed, such as 10 km/h, for more than a predetermined period of time, such as 5 seconds, at decision diamond 62, and if so, determines whether the high voltage battery state-of-charge is sufficient at decision diamond 64, and if so, determines if the FOPS cabin heat or AC are not being requested at decision diamond 66, and if so, determines whether all of the FOPS faults that would prevent a subsequent start-up or a successful shut-down are off at decision diamond 68, and if so, the FOPS control requests that the vehicle be put in the stand-by mode at the box 44. If any of the entrance criteria at the diamonds 62, 64, 66 and 68 has not been met, then the FOPS controller does not request that the system be put in the stand-by mode at box 70, and returns to the box 32 to determine if the fuel cell module is in the run state, if the key is in the run position and if the off-time has been reset.

If the vehicle is in the low power condition at the decision diamond 58, the FCS controller determines whether the system will be put into the stand-by mode by first determining whether the stand-by bit is one at decision diamond 72, and if so, determines if the FCS cooling fluid outlet temperature is greater than the predetermined temperature value, such as 55° C., and whether the ambient temperature T_{amb} is greater than the predetermined temperature value, such as −15° C., at decision diamond 74, and if so, determines if the service indicator light is off at decision diamond 76, and if so, determines if the ambient temperature T_{amb} is less than the predetermined temperature value, such as 5° C., when the stand-by mode was engaged more than some previous predetermined time period, such as 5 minutes, at decision diamond 78, and if so, the vehicle requests the stand-by mode at the box 44. If any of the entrance criteria at the decision diamonds 72, 74, 76 and 78 has not been satisfied, then the FCS controller determines that the vehicle will not be put in the stand-by mode at the box 56, and then returns to the box 32 to determine if the fuel cell module is in the run state, the key is in the run position, and the off-time is reset.

If the FCPS controller and the FCS controller determine that the stand-by mode is OK at the box 44, then the algorithm goes through a process for performing predetermined criteria and procedures to prepare the system and enter the stand-by mode at box 80. Once those procedures have been performed, the vehicle is in the stand-by mode at box 82.

The algorithm then monitors various vehicle parameters, devices and systems to determine whether any of the exit criteria have been met to exit the stand-by mode. At the vehicle level, the algorithm determines whether the vehicle will stay in the stand-by mode by determining if the key is still in the run position at decision diamond 84, and if so, the stand-by mode is still proper. The algorithm also determines if the battery state-of-charge is still high enough for a certain start condition, such as a greater than 5 kW, second start and a greater than 3 kW, 30 second start, at decision diamond 86 to stay in the stand-by mode, and if so, the stand-by mode is still proper. The algorithm also determines whether the PRNDL position is still park at decision diamond 88, and if so, determines if the cabin heat request is still off at decision diamond 90, and whether the brake is not being applied at decision diamond 92, and if so, the stand-by mode is still proper at the box 82.

If the PRNDL position is not park at the decision diamond 88, then the algorithm moves to the other requirement for being in the stand-by mode, where the vehicle is in the low power condition or in the economy mode. Particularly, the algorithm determines if the PRNDL position is low at decision diamond 94, and if so, the operator is requesting the economy mode. In this case, a “red PERF telltale” is set at box 96, which causes an indicator to be illuminated on the instrument panel that indicates that the vehicle is in the reduced performance mode due to the economy mode request. If the vehicle is still in the low power condition or economy mode, then the algorithm also determines if the cabin heat request is on and if the ambient temperature is less than the predetermined value, such as 5° C., at decision diamond 98, and whether the vehicle speed is less than a predetermined speed value, such as 10 km/h, at decision diamond 100. If the cabin heating request is not on, the ambient temperature is greater than 5° C. and the vehicle speed is less than 10 km/h, then the stand-by mode is still proper and the algorithm returns to the box 82.

If the key is not in the run position at the decision diamond 84, the battery state-of-charge is not sufficient at the decision diamond 86, the cabin heat request is on at the decision diamond 90, the brake apply is not off at the decision diamond 92, the cabin heat request is on and the ambient temperature T_{amb} is below 5° C. at the decision diamond 98, the vehicle speed is greater than 10 km/h at the decision diamond 100, or the position of the PRNDL is not low at the decision diamond 94, meaning that the vehicle is not in the economy mode, then the algorithm determines that one of the vehicle level stand-by exit criteria has been satisfied and the stand-by mode is not OK at box 102.

For the fuel cell level, the FCS controller determines if the cooling fluid outlet temperature is less than a predetermined temperature, such as 40° C., at decision diamond 104, and whether the stand-by mode maximum time limit has been reached at decision diamond 106, and if neither of these criteria are met, then the stand-by mode is still proper for the fuel cell system at box 82. If, however, the cooling fluid temperature is too low at the decision diamond 104 or the stand-by mode time limit has been reached at the decision diamond 106, then the stand-by mode is no longer OK for the fuel cell level at box 108.

If the vehicle exits the stand-by mode at the box 102 or 108 or the procedures for entering the stand-by mode are not performed at the box 80, then the algorithm determines whether the key is in the run position at decision diamond 110, and if not, then the algorithm determines if a freeze shut-down sequence is required at decision diamond 112, and if not, a normal shut-down procedure is performed at box 114. If a freeze shut-down is required at decision diamond 112, then that shut-down is performed at box 116.

If the key is in the run position at the decision diamond 110, then a start-up sequence is performed at box 118, and the algorithm determines if the start-up is successful at decision diamond 120. If the start-up sequence was successful at the decision diamond 120, then the algorithm goes to the box 32 to determine whether the fuel cell module is in the run state, the key is in the run position and the off-time is reset. If the start-up sequence was not successful, the algorithm performs a driver key cycle for restart attempt at box 122 and sets the stand-by bit to zero at box 124.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for putting a fuel cell vehicle in a stand-by mode and removing the fuel cell vehicle from the stand-by mode, said method comprising:
determining whether predetermined stand-by mode vehicle level entrance criteria have been satisfied at a vehicle control level;
determining whether predetermined stand-by mode fuel cell level entrance criteria have been satisfied for a fuel cell system control level; and
putting the vehicle in the stand-by mode if both the vehicle level entrance criteria and the fuel cell level entrance criteria have been satisfied.

2. The method according to claim 1 wherein the vehicle level entrance criteria include that a vehicle key is in a run position and the fuel cell system entrance criteria include that the fuel cell system is in a run state and a predetermined fuel cell run time is greater than a predetermined threshold.

3. The method according to claim 1 wherein the vehicle level entrance criteria include that the vehicle is in park or a vehicle power level is in a low or economy condition.

4. The method according to 1 wherein the vehicle level entrance criteria include that the vehicle brakes have been off for a predetermined period of time, a high voltage battery state of charge is above a predetermined threshold, vehicle cabin heating or AC is not being requested and that any vehicle level faults that would prevent a subsequent start-up or a successful shut-down are off.

5. The method according to claim 1 wherein the fuel cell system level entrance criteria include that a stand-by bit is one indicating stand-by is OK, a fuel cell system coolant outlet temperature is greater than a predetermined temperature value, an ambient temperature is greater than a predetermined temperature value, a service indicator light is off and the ambient temperature is less than the predetermined temperature when a stand-by mode is engaged greater than a predetermined period of time if the vehicle is in park.

6. The method according to claim 1 further comprising exiting the stand-by mode if predetermined vehicle level stand-by mode exit criteria have been satisfied or predetermined fuel cell level stand-by mode exit criteria have been satisfied.

7. The method according to claim 6 wherein the vehicle level exit criteria includes whether the vehicle key is in a run position, whether a PRNDL position is park or whether a PRNDL position is low.

8. The method according to claim 6 wherein the vehicle level exit criteria include whether the battery state of charge is below a predetermined threshold, that cabin heating is being requested, a brake apply state is not off, the ambient temperature is below a predetermined temperature and the vehicle speed is not below a predetermined speed threshold.

9. The method according to claim 6 wherein the fuel cell level exit criteria include that a stack coolant temperature is below a predetermined temperature value and that a predetermined maximum stand-by mode time limit has been reached.

10. The method according to claim 1 further comprising determining whether a freeze shut down or a normal shut-down will be performed after the vehicle exits the stand-by mode.

11. A method for putting a fuel cell vehicle in a stand-by mode and removing the fuel cell vehicle from the stand-by mode, said method comprising:
determining whether predetermined stand-by mode vehicle level entrance criteria have been satisfied at a vehicle control level where the vehicle level entrance criteria includes that a vehicle key is in a run position, the vehicle is in park or a vehicle power level is in a low power or economy condition;
determining whether predetermined stand-by mode fuel cell level entrance criteria have been satisfied for a fuel cell system control level, where the fuel cell level entrance criteria include that the fuel cell vehicle is in a run state and a predetermined fuel cell run time is greater than a predetermined threshold;
putting the vehicle in the stand-by mode if both the vehicle level entrance criteria and the fuel cell level entrance criteria have been satisfied; and
exiting the stand-by mode if predetermined stand-by mode vehicle level exit criteria have been satisfied or predetermined stand-by mode fuel cell level exit criteria have been satisfied, where the vehicle level exit criteria include that a battery state-of-charge is below a predetermined threshold, the vehicle is not in park and the vehicle is not in a low power or economy position.

12. The method according to 11 wherein the vehicle level entrance criteria further include that the vehicle brakes have been off for a predetermined period of time, a high voltage battery state of charge is above a predetermined threshold, vehicle cabin heating or AC is not being requested and that any vehicle level faults that would prevent a subsequent start-up or a successful shut-down are off.

13. The method according to claim 11 wherein the fuel cell system level entrance criteria further include that a stand-by bit is one indicating stand-by is OK, a fuel cell system coolant outlet temperature is greater than a predetermined temperature value, an ambient temperature is greater than a predetermined temperature value, a service indicator light is off and the ambient temperature is less than the predetermined temperature when a stand-by mode is engaged greater than a predetermined period of time if the vehicle is in park.

14. The method according to claim 11 wherein the vehicle level exit criteria further include whether the battery state of charge is below a predetermined threshold, that cabin heating is being requested, a brake apply state is not off, the ambient temperature is below a predetermined temperature and the vehicle speed is not below a predetermined speed threshold.

15. The method according to claim 11 wherein the fuel cell level exit criteria further include that a stack coolant temperature is below a predetermined temperature value and that a predetermined maximum stand-by mode time limit has been reached.

16. The method according to claim 11 further comprising determining whether a freeze shut down or a normal shut-down will be performed after the vehicle exits the stand-by mode.

17. A system for putting a fuel cell vehicle in a stand-by mode and removing the fuel cell vehicle from the stand-by mode, said system comprising:
means for determining whether predetermined stand-by mode vehicle level entrance criteria have been satisfied at a vehicle control level;
means for determining whether predetermined stand-by mode fuel cell level entrance criteria have been satisfied for a fuel cell system control level; and
means for putting the vehicle in the stand-by mode if both the vehicle level entrance criteria and the fuel cell level entrance criteria have been satisfied.

18. The system according to claim 17 wherein the vehicle level entrance criteria include that a vehicle key is in a run position and the fuel cell system entrance criteria include that the fuel cell system is in a run state and a predetermined fuel cell run time is greater than a predetermined threshold.

19. The system according to claim 17 wherein the vehicle level entrance criteria include that the vehicle is in park or a vehicle power level is in a low or economy condition.

20. The system according to claim 17 further comprising means for exiting the stand-by mode if predetermined vehicle level stand-by mode exit criteria have been satisfied or predetermined fuel cell level stand-by mode exit criteria have been satisfied.
